(19) United States
(12) Patent Application Publication
(10) Pub. No.: US 2026/0347967 A1
(43) Pub. Date: Nov. 5, 2026

(54) METHOD AND SYSTEM FOR RECOVERING LITHIUM FROM BRINE

(71) Applicant: DDP SPECIALTY ELECTRONIC MATERIALS US, LLC, Wilmington, DE (US)

(72) Inventors: Tirtha CHATTERJEE, Wilmington, DE (US); Steven JONS, Edina, MN (US); Matthew OLSEN, MATTHEW, Wilmington, DE (US); TONI Marie BECHTEL, Edina, MN (US)

(21) Appl. No.: 19/101,763

(22) PCT Filed: Sep. 21, 2023
(86) PCT No.: PCT/US23/74749

§ 371 Date: Feb. 6, 2025

Related U.S. Application Data
(60) Provisional application No. 63/409,404, filed on Sep. 23, 2022.

(51) Int. Cl. C22B 7/00; C22B 26/12

(52) U.S. Cl. CPC C22B 7/005; C22B 26/12

(57) ABSTRACT

Provided herein are a method and system to selectively recover lithium with improved mass recovery and high purity. The method includes providing an initial feed with a dissolved mass of lithium ions and (i) an initial ratio of monovalent anions to lithium ions, (ii) an initial ratio of multi-valent cations to lithium ions, and (iii) an initial ratio of monovalent anions to multi-valent anions that is less than one; adding one or more salts to the initial feed to create an adjusted feed with pH between 1 and 7 and an adjusted ratio of monovalent anions to lithium ions that is more than the initial ratio of monovalent anions to lithium ions; and passing a portion of the adjusted feed through a membrane filter unit to produce a first outlet stream and a second outlet stream, wherein at least half of the mass of lithium ions present in the initial feed is partitioned into the first outlet stream and the first outlet stream has a ratio of multi-valent cations to lithium ions that is less than half of the initial ratio of multi-valent cations to lithium ions; and extracting the lithium ions from the first outlet stream.

### CROSS-REFERENCE TO RELATED APPLICATION

The present application claims priority under 35 U.S.C. § 365(c) to U.S. Provisional Appln. No. 63/409,404, filed on Sep. 23, 2022, which is incorporated herein by reference in its entirety.

### STATEMENT REGARDING FEDERALLY SPONSORED RESEARCH

This invention was made with U.S. government support under Government Contract No. DE-EE0009430 awarded by the U.S. Department of Energy, Office of Energy Efficiency & Renewable Energy. The U.S. government has certain rights in this invention.

### FIELD OF THE INVENTION

The present invention relates to a method and system for the recovery of lithium from natural or synthetically generated brines. In particular, the method includes an adjustment of the ion concentration of the feed prior to a hyperfiltration step.

### BACKGROUND OF THE INVENTION

Several patents, patent applications and publications are cited in this description in order to more fully describe the state of the art to which this invention pertains. The entire disclosure of each of these patents, patent applications, and publications is incorporated by reference herein.

Lithium (Li) is a key component in high-energy-density lithium-ion batteries. Lithium-ion batteries are used in a variety of applications including electric vehicles, computers, and energy storage devices, among others. An increase of the global demand for lithium is anticipated in the foreseeable future. Currently, industrial-scale Li-extraction technology employs chemical treatments followed by evaporation-based processes to recover lithium from different natural and recycled sources, which is time consuming and needs a large-footprint operation. Moreover, a large amount of water evaporation is needed to recover Li and most of the natural Li sources are in arid regions with limited clean water availability. To speed up the evaporation process and recover water, engineered processes such as thermal evaporation followed by condensation have been applied, but these are still energy inefficient.

Various membrane-based processes have been described to recover lithium from natural and recycled sources. U.S. Pat. No. 10,450,633 ('633) describes a membrane-based process to recover Li from acid solutions. A processing-step described in '633 is to pass the acidic lithium solutions through a nanofiltration (NF) membrane unit where a fraction of acid and lithium solution permeates through the NF membrane. U.S. Pat. No. 6,004,464 describes a brine reclamation process from a water-softening resin unit that includes acidifying a chloride-containing brine to a pH range of 0.5-6 and then adding a salt with a monovalent cation and multi-valent anion (such as Na₂SO₄) to this pH-adjusted brine. CN 112,850,851 describes a Li separation process from a Na₂SO₄-type salt lake brine that involves adding a chloride (Cl⁻) salt to the brine and pumping it through an NF system at a pH range of 7.5-11.0 to obtain a superior Li⁺/Mg²⁺ separation. CN 108,063,295 describes a process of extracting Li and other heavy metals from a battery source using hydrochloric acid, wherein Li₂SO₄ is added to this acidic feed to react for about 30 minutes under stirring to generate LiCl and CaSO₄, which are further separated using an NF membrane.

Nevertheless, there remains a need for better water management processes with high lithium recovery for specific feeds, particularly those that include multi-valent anions (e.g. SO₄²⁻, CO₃²⁻) and those that are located in water-scarce regions.

### SUMMARY OF THE INVENTION

Accordingly, provided herein is a method of recovering lithium ions comprising providing an initial feed with a dissolved mass of lithium ions and (a) an initial ratio of monovalent anions to lithium ions, (b) an initial ratio of multi-valent cations to lithium ions, and (c) an initial ratio of monovalent anions to multi-valent anions that is less than one. The method comprises adding one or more salts to the initial feed to create an adjusted feed with pH between 1 and 7 and an adjusted ratio of monovalent anions to lithium ions that is more than the initial ratio of monovalent anions to lithium ions. The method further comprises passing a portion of the adjusted feed through a membrane unit to produce a first outlet stream and a second outlet stream, wherein at least half of the lithium mass present in the initial feed is partitioned into the first outlet stream and the first outlet stream has a ratio of multi-valent cations to lithium ions that is less than half the initial ratio of multi-valent cations to lithium ions.

Further provided herein is a system for recovering lithium comprising: means for providing an initial feed having a dissolved mass of lithium ions, wherein the initial feed contains (a) an initial ratio of monovalent anions to lithium ions, (b) an initial ratio of multi-valent cations to lithium ions, and (c) an initial ratio of monovalent anions to multi-valent anions that is less than one; means for adding one or more salts to the initial feed to create an adjusted feed with pH between 1 and 7 and an adjusted ratio of monovalent anions to lithium ions that is more than the initial ratio of monovalent anions to lithium ions, a membrane filter unit; and means for passing a portion of the adjusted feed through the membrane filter unit to produce a first outlet stream and a second outlet stream, wherein at least half of the mass of lithium ions present in the initial feed is partitioned into the first outlet stream and the first outlet stream has a ratio of multi-valent cations to lithium ions that is less than half of the initial ratio of multi-valent cations to lithium ions. The system optionally may further comprise: means for fractionating the second outlet stream to form a part that is enriched in ions selected from monovalent anions and multi-valent cations, and means for recycling at least a portion of the enriched part into the adjusted feed.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

FIG. 1 is a schematic drawing of a system suitable for use in the methods described herein for recovering lithium from an initial feed of brine solution containing dissolved lithium;

FIG. 2 is a schematic drawing of another system that is suitable for use in the lithium recovery methods described herein;

FIG. 3 is a schematic drawing of yet another system that is suitable for use in the lithium recovery methods described herein; and,

FIG. 4 is a schematic drawing of yet another system that is suitable for use in the lithium recovery methods described herein.

### DETAILED DESCRIPTION OF THE INVENTION

Unless otherwise defined, all technical and scientific terms used herein have the same meaning as commonly understood by one of ordinary skill in the art to which this invention belongs. Although methods and materials similar or equivalent to those described herein can be used in the practice or testing of the embodiments set forth herein, suitable methods and materials are described below.

As used herein, the terms “includes,” “including,” “has,” “having,” “contains,” “containing” or any other variation thereof, refer to a non-exclusive inclusion. For example, a process, method, article, or apparatus that includes a list of elements is not necessarily limited to those elements, but may include other elements not expressly listed or inherent to such process, method, article, or apparatus.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.” Where an invention or a portion thereof is described with an open-ended term such as “comprising,” it is to be understood that, unless otherwise stated in specific circumstances, this description also includes a description of the invention using the terms “consisting of” and “consisting essentially of”.

Further, unless expressly stated to the contrary, “or” refers to an inclusive “or” and not to an exclusive “or.” For example, a condition A or B is satisfied by any one of the following: A is true (or present) and B is false (or not present), A is false (or not present) and B is true (or present), and both A and B are true (or present).

Also, use of “a” or “an” are employed to describe elements and components of the invention. This is done merely for convenience and to give a general sense of the invention. This description should be read to include one or at least one and the singular also includes the plural unless it is obvious that it is meant otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In addition, the ranges set forth herein include their endpoints unless expressly stated otherwise in limited circumstances. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

Moreover, where a range of numerical values is recited herein, unless otherwise stated in specific circumstances, the range is intended to include the endpoints thereof, and all real numbers within the range. It is not intended that the scope of the invention be limited to the specific values recited when defining a range. Finally, when the term “about” is used in describing a value or an end-point of a range, the disclosure should be understood to include the specific value or end-point referred to.

Finally, as used herein, the term “lithium” as used alone or in combined form, refers to lithium ions, unless it is clear in context that lithium metal (Li⁰) is described.

A method and system to selectively recover lithium with good mass recovery and high purity are provided herein. The method comprises providing an initial feed with a dissolved mass of lithium ions. Preferably, the concentration of lithium in the initial feed, or in waters of interest for use as the initial feed, is between 0.05 g/L and 6 g/L, more preferably between 0.1 g/L and 3 g/L. For a given volume, the dissolved mass of lithium may be calculated by multiplying the volume by the concentration of dissolved lithium.

The initial feed may comprise monovalent and multi-valent cations, mono and multi-valent anions, soluble organics, dissolved materials, and suspended particles such as, but not limited to, colloidal silica and clay. In addition to lithium ions, other monovalent cations that may be present in the initial feed include cations of sodium (Na), potassium (K), cesium (Cs), and rubidium (Rb). Various multi-valent cations that may be present in the initial feed include ions of Mg, Ca, Mn, Fe, Cu, Al, Sr, Ba, Ti, Zn, Cd, and Pb in any oxidation state that is stable in aqueous solution. The initial feed may come from a natural source such as a salt lake or a salar or a geothermal brine or from clay mining or a hard rock deposit. The initial feed may be generated synthetically by acid-digesting a lithium-containing material such as, but not limited to, lithium-ion batteries, solar panels, solar storage devices, computers, laptops, and like devices. Alternatively, the initial feed can be a processed feed which is generated by processing a natural resource brine or a synthetically generated brine.

The initial feed has an initial ratio of monovalent anions to lithium ions. Some common monovalent anions include Cl⁻, Br⁻, F⁻, OH⁻, and HCO₃⁻. The initial ratio of monovalent anions to lithium ions depends on source, extraction process, and preceding unit operations. Preferably, the initial feed is depleted in monovalent anions, with the initial ratio of monovalent anions to lithium ions of less than 1, and more preferably less than 0.5, and even more preferably less than 0.2. In some cases, there may be no measureable amount of monovalent anions in the initial feed other than small amounts of hydroxide from water dissociation. For a given volume, the initial ratio of monovalent anions to lithium ions may be calculated by dividing the total molar concentration of dissolved monovalent anions by the molar concentration of dissolved lithium ions. For a given volume, the molar concentration may be calculated by measuring the dissolved mass of an ion per unit volume and dividing it by the corresponding molar mass. For example, the molar concentration of lithium ion (Li⁺) in units of mol/L may be calculated as the measured dissolved mass of lithium ion per L of solution divided by lithium-ion molar mass (6.941 amu).

The initial feed has an initial ratio of multi-valent cations to lithium ions. Multi-valent cations in the initial feed commonly include magnesium (Mg²⁺) and calcium (Ca²⁺), but the initial mix and ratio of multi-valent cations to lithium ions depends on source, extraction process, and preceding unit operations. For a given volume, the initial ratio of multi-valent cations to lithium ions may be calculated by dividing the total molar concentration of dissolved multi-valent cations by the molar concentration of dissolved lithium ions. Preferably, the initial ratio of multi-valent cations to lithium ions is at least 0.10, more preferably at least 1.0, still more preferably at least 10.0.

The initial feed has an initial ratio of monovalent anions to multi-valent anions that is less than one. For instance, in a feed containing anions of only chloride (35.45 amu) and sulfate (96.06 amu), a ratio of less than 1 corresponds to less than 27% chloride by anion mass. Common multi-valent anions include SO₄²⁻, HPO₄²⁻, PO₄³⁻, and CO₃²⁻. Advantageously, the anions in an initial feed may be dominated (more than 50% of the total molar concentration of anions) by a combination of SO₄²⁻ and CO₃²⁻, and more preferably the anions are dominated by SO₄²⁻ only.

Several lithium-containing solutions may be advantageously treated by the methods and systems described herein. For example, many natural brine sources comprise SO₄²⁻ as one of the key anions (e.g. a sodium-sulfate subtype or a magnesium-sulfate subtype brine), and sulfate-subtype brines are often characterized by a high Mg/Li ion ratio, for example >5. Brines extracted from hard rocks, clay mining or lithium-containing materials such as, for example, lithium-ion batteries, solar panels, solar storage devices, computers, laptops, and like devices may also comprise high levels of SO₄²⁻, particularly if H₂SO₄ is used as an extractor. More preferably, the initial feed is rich in multi-valent anions and depleted in monovalent anions with the initial ratio of monovalent anions to multi-valent anions being less than 1, preferably less than 0.5, and even more preferably less than 0.2.

The initial feed pH range can be wide, for instance, between pH 0 and pH 10, inclusive. Examples of particularly relevant lower pH brines (pH range 0 to 3) include brines produced from hard rock extractions, clay mining and those resulting from digesting lithium-containing materials using an acid or an aqueous solution of the acid. Examples of higher pH (pH range 4 to 10) brines include those obtained from a salt lake or a salar or a geothermal source. The initial feed pH also depends on the processing conditions of any or all unit operations or steps involved prior to its creation. The method described herein comprises a step of adding one or more salts to the initial feed to create an adjusted feed. As used herein, the term ‘salts’ refers to solid salts and to salts that are dissolved in water. One or more of dissolved salts, dispersed salts, suspended salts, or solid salts may be present in the initial feed or in the adjusted feed. Solid salts may be in a hydrated or anhydrous form. As used herein, the term “salts” also refers to acids and bases. Non-limiting examples of acids include HCl, H₂SO₄, HNO₃, and H₃PO₄, and non-limiting examples of bases include NaOH, LiOH, KOH, Ca(OH)₂, and Mg(OH)₂. The addition of salts to any composition may take place in one or more steps, via the addition of one or more salts in solid, suspended, dispersed, or dissolved form. When a salt is described herein as “dissolved,” the solution may also include dispersed or suspended particles of the salt.

In the methods described herein, the adjusted feed has a pH between 1 and 7 and an adjusted ratio of monovalent anions to lithium ions that is more than the initial ratio of monovalent anions to lithium ions. Preferably the pH of the adjusted feed is greater than 2, and more preferably greater than 3. Preferably the pH of the adjusted feed is less than 6. The adjusted ratio of monovalent anions to lithium ions, that is, the ratio in the adjusted feed, is more than 1, more preferably more than 2, and still more preferably more than 4.

In some preferred methods, the pH of the adjusted feed is less than the pH of the initial feed. For purposes of decreasing pH, non-limiting examples of suitable acids that may be added to the initial feed include HCl, HNO₃, H₂SO₄, and H₃PO₄. Of these, HCl and HNO₃ are preferred, because chloride and nitrate salts also increase the ratio of monovalent anions to lithium ions in the adjusted feed. These acids may be added in their pure form or as a diluted solution in water.

In other preferred methods, the pH of the adjusted feed is greater than the pH of the initial feed. For purposes of increasing pH, non-limiting examples of suitable bases that may be added to the initial feed include hydroxide salts (e.g. NaOH, KOH, LiOH, Mg(OH)₂, or Ca(OH)₂), carbonate salts (e.g. NaHCO₃, KHCO₃, Ca(HCO₃)₂, MgCO₃, or CaCO₃), and alkaline oxides such as quicklime (CaO). Among these, species containing a multi-valent cation may be used to both increase pH and to increase the adjusted ratio of multi-valent cations to lithium ions. These salts may be added in their pure form or as a diluted solution in water.

In some methods, a precipitation and/or suspension may be caused by the initial feed pH adjustment. The precipitated and/or suspended solids may be subsequently removed by a settling operation, by centrifugation, or by using filtration equipment (e.g. media filter, sand filter, ultrafiltration membrane, or microfiltration membrane). In particular, an advantageous method for removal of solids from the adjusted feed is ultrafiltration. The adjusted feed is then defined as the solution with dissolved ions present that pass across the ultrafiltration membrane surface.

In some preferred methods, an adjusted ratio of monovalent anions to lithium ions that is more than the initial ratio of monovalent anions to lithium ions may be achieved by adding common salts containing monovalent anions. For this purpose salts may be selected from a group of chloride salts such as, but not limited to, NaCl, KCl, MgCl₂, CaCl₂ in their hydrated or anhydrous form, or nitrate salts such as, but not limited to, NaNO₃, KNO₃, Mg(NO₃)₂, Ca(NO₃)₂ in their hydrated or anhydrous form or a carbonate salt such as, but not limited to, NaHCO₃, KHCO₃, Ca(HCO₃)₂, MgCO₃ or CaCO₃ in their hydrated or anhydrous form. Among these, the salts containing a multi-valent cation may be used to also increase the adjusted ratio of multi-valent cations to lithium ions simultaneously.

To maximize passage of lithium ions and to decrease the ratio of multi-valent cations to lithium ions in a membrane permeate stream (the portion of adjusted feed that passes through the hyperfiltration membrane), it has been found that added salts preferably contain multi-valent cations to increase the adjusted ratio of multi-valent cations to lithium ions.

In some preferred methods, adjustment of the initial feed pH and adjustment of the ratio of the ions may be done in a single step. This may be accomplished by adding a mixture of salts to the initial feed. For this purpose, a monovalent anion containing salt, such as a chloride salt or a nitrate salt, is preferred. This salt may be dissolved in an acidic solution (to lower the initial feed pH to the preferred range for the adjusted feed) or in a basic solution (to raise the initial feed pH to the preferred range for the adjusted feed). More preferably the monovalent anionic salts also contain multi-valent cations to increase the adjusted ratio of multi-valent cations to lithium ions. In other methods, where pH of the adjusted feed is greater than pH of the initial feed, adjustment of the initial feed pH and adjustment of the ratio of the ions may be done simultaneously by adding a carbonate salt such as CaCO₃ or MgCO₃ in their solid form or dissolved in water.

In some preferred methods, adjustment of the initial feed pH and the ratio of the ions may be done in multiple steps. Ion adjustment may be done by adding a solid or a dissolved mass of salts containing monovalent anions, such as a Cl⁻ or a NO₃⁻ salt, to the initial feed, and pH adjustment may be done by adding an acid or a base to the initial feed separately in any sequence. In some methods, a pH modification can induce precipitation. In preferred methods of this type, a filtration step (e.g. ultrafiltration) to remove a solid precipitate or suspension may be performed before, during, or after completing the addition of salts. For instance, several Examples of the invention set forth hereinbelow illustrate an addition of salts to the initial feed, which modifies the pH and causes precipitation.

The methods described herein include passing the adjusted feed (as described above) through a membrane unit to partition it between a first outlet stream and a second outlet stream. The first outlet stream comprises liquid that has permeated the membrane. In preferred methods, the first outlet stream contains most of the monovalent cations from the adjusted feed and the second outlet stream contains most of the divalent anions from the adjusted feed. The membrane unit comprises a hyperfiltration membrane, and the adjusted feed is passed across at least one hyperfiltration membrane under pressure, wherein a portion of the adjusted feed permeates through the hyperfiltration membrane. As used herein, the term “membrane permeate” refers to the portion of the adjusted feed that passes through the membrane, and the term “membrane reject” refers to that remaining part of the adjusted feed that does not pass through the membrane. Accordingly, in the absence of permeate recycle loops or brine recycle loops, the first outlet stream is the membrane permeate, and the second outlet stream is the membrane reject. The term “hyperfiltration” as used herein refers to reverse osmosis and to nanofiltration. Most preferably, the membrane unit comprises nanofiltration membranes.

The membrane unit may comprise a membrane in a flat sheet, hollow-fiber, or tubular configuration. Preferably, a flat sheet membrane is provided within a spiral-wound module. A plurality of such spiral-wound membrane modules can be axially aligned in serial arrangement within the chamber of a cylindrical pressure vessel to increase the available active membrane area. The membrane unit may further comprise multiple pressure vessels arranged in parallel or in series. Suitable membranes and units are well known in the art and are available commercially from DuPont de Nemours, Inc., of Wilmington, DE, under the trade name FilmTec™ reverse-osmosis membranes. Suitable methods for synthesizing the membranes are described in U.S. Pat. No. 4,277,344, issued to Cadotte.

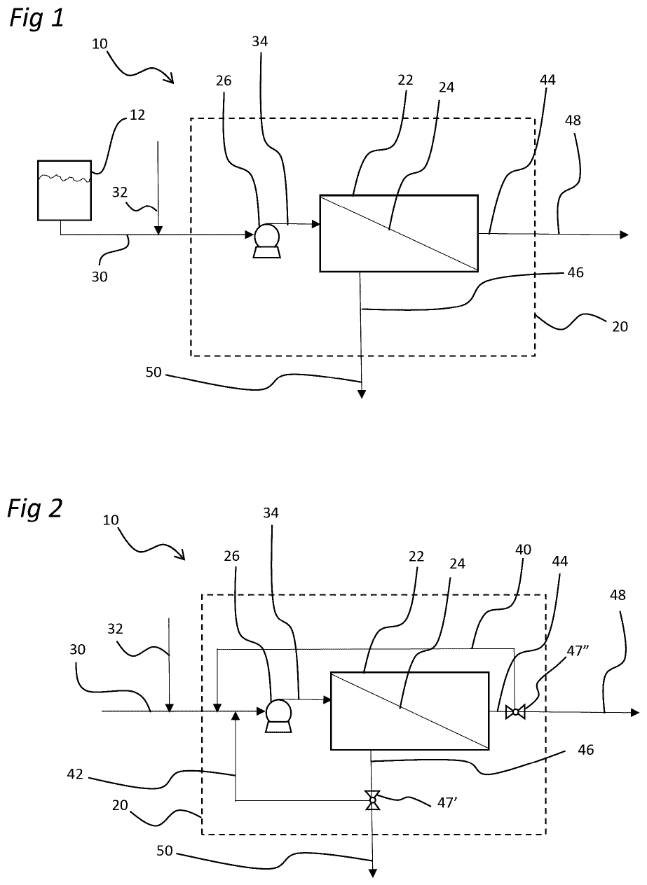

Referring now to the drawings, wherein like reference numerals designate corresponding structure throughout the views, and referring in particular to FIGS. 1 through 4, the systems described herein, and particularly the membrane units in these systems, may have more than one operative configuration or operating procedure. Not all of the operative configurations or operating procedures are depicted in the Figures. Nevertheless, in each method and system that is described herein, an appropriate additive stream enables the initial feed pH, the concentrations of the monovalent anions in the initial feed, and optionally the concentration of the lithium ions in the initial feed to be modified to produce an adjusted feed wherein the ratio of the monovalent anions to the lithium ions is increased relative to that of the initial feed.

FIG. 1 illustrates a lithium recovery system 10 suitable to treat an initial feed containing lithium ions by passing it though the membrane unit 20. The membrane unit 20 contains at least one membrane module 22, symbolically shown by the combination of a rectangle and a diagonal line that itself represents the membrane 24. The at least one membrane module 22 may be of any size suitable to the parameters of the desired process. For example, it may be small (e.g. one or more small test cells containing a few cm² total area of active membrane 24) or it may comprise many vessels in series or parallel, each vessel containing more than 100 m² area of membrane 24. Alternatively, intermediate values may be chosen for the size of the modules and the area of the membrane(s) 24.

The system 10 may be operated continuously, or in a batch-wise mode where a discrete volume of initial feed is treated before re-batch. In a batch-wise process, (not shown) the initial feed may be adjusted at the start of the batch cycle, for example within a feed tank 12. Alternatively, as illustrated in FIG. 1, at least one additive stream 32 may continuously be added to modify the initial feed stream 30 as it flows toward the membrane 24, creating an adjusted feed stream 34. In this way, the adjusted feed stream 34 has the desired pH and composition when it traverses the at least one membrane module 22. Within the membrane unit 20, a feed pump 26 provides pressure to cause a portion of the adjusted feed stream 34 to permeate the membrane 24. A membrane permeate stream 44 passes through the membrane 24 and a membrane reject stream 46 contains the remaining part of the adjusted feed stream 34. In the absence of any permeate recycle or brine recycle loops, the membrane permeate stream 44 becomes the first outlet stream 48 of the membrane unit 20 and the membrane reject stream 46 becomes the second outlet stream 50 of the membrane unit 20.

FIG. 2 illustrates a lithium recovery system 10 appropriate for continuous operation, this time including recycle loops that enable a part of the membrane permeate stream 44 and/or membrane reject stream 46 to be re-introduced for subsequent treatment by the membrane. Again, the membrane unit 20 contains at least one membrane module 22. In a continuous process, the initial feed steam 30 is combined with at least one additive stream 32 to enable addition of salt and adjustment of pH. An adjusted feed stream 34 which flows across the filtration membrane 24 comprises the initial feed stream 30 and at least one additive stream 32. While shown with two recycle loops, this continuous system may optionally have included only a permeate recycle loop 40, only a reject recycle loop 42, neither (as depicted in FIG. 1), or both.

The order in which these recycled streams are added to the initial feed or are combined together (before adding to the initial feed) is not limiting. For example, initial feed stream 30 is mixed with additive stream 32 before entering the membrane unit 20. Within the membrane unit 20, however, permeate recycle loop 40 may be added to combined streams 30 and 32 first, then reject recycle loop 42; reject recycle loop 42 can be mixed with the combined streams 30 and 32 first, then with permeate recycle loop 40; or permeate recycle loop 40 and reject recycle loop 42 may be mixed together, and this combined stream may then be mixed with a stream that results from combining the initial feed stream 30 and at least one additive stream 32. One of skill in the art readily recognizes that these and other configurations of the lithium recovery system 10 are suitable to practice the methods described herein. In a continuous process, even one having permeate and/or reject recycle loops (40, 42), the adjusted feed stream 34 passing across the membrane 24 can maintain a constant composition over time. In the illustrated embodiment, a feed pump 26 pressurizes the combined adjusted feed stream 34. In other cases (not depicted), components making up the adjusted feed stream 34 may be separately pressurized. For example, the additive stream 32 may be pressurized and injected after the feed pump 26. In another example, already pressurized reject recycle loop 42 can directly be mixed with pump 26 outlet creating adjusted feed 34 entering the membrane module 22. As shown in FIG. 2, the adjusted feed stream 34 is split by the membrane 24 into a membrane permeate stream 44 that passes through the filtration membrane 24 and a membrane reject stream 46 that does not. All of the fluid from the membrane permeate stream 44 that is not diverted (preferably controlled by an optional valve, 47″) to the permeate recycle loop 40 flows into the first outlet stream 48 of the membrane unit 20. Similarly, all of the fluid from the membrane reject stream 46 that is not diverted (preferably controlled by an optional valve 47′) to the reject recycle loop 42 flows into the second outlet stream 50 of the membrane unit 20. In a preferred embodiment, the membrane system 10 comprises a reject recycle loop 42 and not a permeate recycle loop 40, as this enables the membrane unit 20 to attain a higher recovery with a smaller amount of active membrane area.

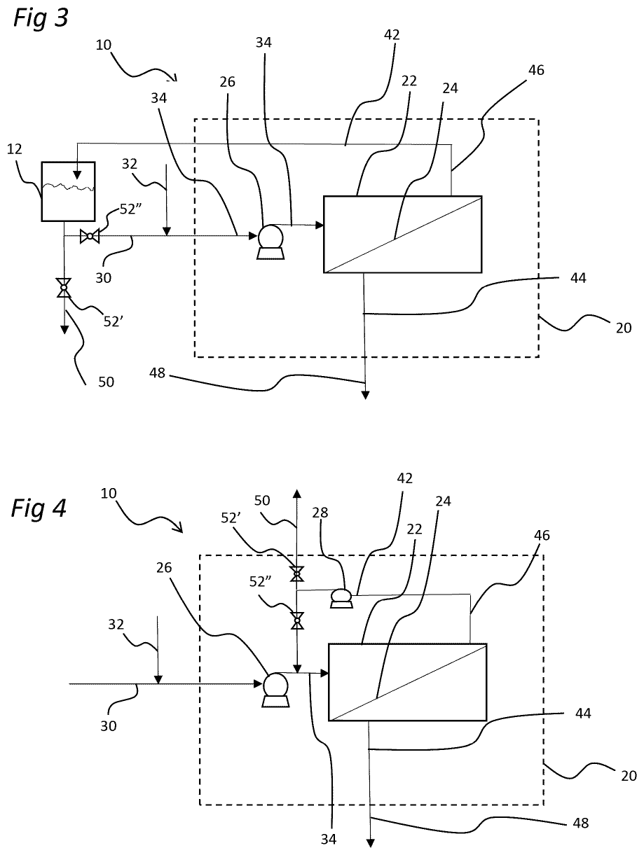

FIG. 3 illustrates a configuration suitable for a semi-batch process, where permeate is produced continuously within the batch cycle and feed tank 12, including at least part of the membrane reject stream produced during the batch cycle, is discharged periodically. In such a process, the composition of the adjusted feed 34 varies over time. In the case illustrated, fluid from a reject recycle loop 42 may be continuously mixed with the remaining part of the feed volume. During the first part of the batch cycle, a membrane permeate stream 44 may be continuously removed from the membrane unit 20 as the first outlet stream 48 while the membrane reject stream 46 is mixed back into the feed tank 12 through the reject recycle loop 42. In a subsequent part of the batch cycle, one or more valves (52′, 52″) are arranged to discharge the more concentrated feed stream intermittently as the second outlet stream 50.

In a Closed Circuit Reverse Osmosis (CCRO) design depicted in FIG. 4, a recirculation pump 28 is located within the reject recycle loop 42, with valves 52′, 52″ enabling improved energy efficiency because the existing pressure of the reject recycle loop 42 is not lost when it is discharged through outlet 50 downstream of the high-pressure pump 26. The system of FIG. 4 features periodic dumps of the reject recycle loop 42 through the second outlet stream 50. The arrangements in both FIG. 3 and FIG. 4 provide for at least one additive stream 32 that can create an adjusted feed stream 34 with appropriate pH and ion composition as it flows toward the membrane 24. However, the semi-batch processes in these embodiments cause the composition of the adjusted feed stream 34 flowing across the membrane 24 to change (increase in adjusted feed osmotic pressure) with time during the batch cycle. Comparable CCRO systems have been described for other uses in U.S. Pat. Nos. 7,695,614 and 8,025,804, both issued to Efraty.

The first and second outlet streams 48, 50 of the membrane unit 20 may change in composition with time. This time-dependent variation is inherent for the semi-batch configurations in FIG. 3 and FIG. 4. However, even for the more stable batch and continuous processes, the composition of the membrane permeate stream (or the membrane reject stream) will vary to some extent (e.g. due to changing pump pressure or less controlled conditions like temperature). In the methods and systems described herein, an average composition of the first outlet stream can be understood as being equal to the composition of the combined total output of the first outlet stream of the membrane unit.

The membrane unit 20 is configured and operated to provide a desired recovery, and the term “recovery” may be used in different ways. As used herein, the term “lithium recovery” refers to the mass of lithium contained within the combined total output of the first outlet stream divided by the mass of lithium present in the initial feed which is sent to the membrane unit over the same time. (Neglecting any mass of lithium introduced through the additive streams, recovery of lithium may be approximated by the mass of lithium in the first outlet stream divided by the mass of lithium in both the first and second outlet streams.) Preferably, lithium recovery for the membrane unit exceeds 50%, more preferably 75%, or even 90%. Moreover, the volumetric recovery of the membrane unit is defined as the volume of the first outlet stream divided by the combined volumes of the initial feed stream and additive streams over the same time period. Equivalently, this volumetric recovery for the membrane unit may be calculated from the volumes of the first and second outlet streams, being equal to the volume of the first outlet stream divided by the combined volumes of the first and second outlet streams. Preferably, the volumetric recovery exceeds 70% or even 90%. In a preferred process, the lithium recovery for the membrane unit exceeds the volumetric recovery for the membrane unit.

The arrangement of the membrane unit will impact lithium and volumetric recoveries. For instance, when the same volume of the adjusted feed stream flows across more membrane area in series, an increased volume of the membrane permeate stream is produced and the recovery of the membrane unit is increased. The membrane unit may also include various internal loops for recycling parts of the membrane permeate stream and/or membrane reject streams, and these impact recoveries as well. Although the presence of these internal loops is not considered in the above recovery calculations, their presence will impact both lithium recovery and volumetric recovery. For instance, substantially higher volumetric recovery for the membrane unit may be achieved when a portion of the membrane reject stream is recycled.

When the volumetric recovery of the membrane unit is increased, the volume of the second outlet stream is reduced. Consequently, the concentration of some well-rejected ions (e.g. multi-valent anions) in the second outlet stream preferably becomes higher and the mass of lithium in the second outlet stream is preferably reduced. Since constituents in the adjusted feed passing through the membrane unit are partitioned between the first and second outlet streams, greater volumetric recovery impacts the composition of the first outlet stream as well as the second outlet stream. In preferred embodiments, a portion of the adjusted feed is passed through a membrane unit to produce the first and second outlet streams, and at least half of the mass of lithium present in the initial feed is partitioned into the first outlet stream and the first outlet stream has a ratio of multi-valent cations to lithium ions that is less than half of the initial ratio of multi-valent cations to lithium ions. In more preferred embodiments, the first outlet stream has a ratio of multi-valent cations to lithium ions that is less than 0.25, or even less than 0.1, of the ratio of multi-valent cations to lithium ions in the initial feed.

In some preferred embodiments, additional water may be combined with the initial feed stream and other salts to create an adjusted feed stream with a decreased concentration of multi-valent anions compared to the concentration of multi-valent anions in the initial feed. Preferably, the molar concentration (mol/L) of multi-valent anions in the adjusted feed is less than 90% of the molar concentration (mol/L) of multi-valent anions in the initial feed. More preferably, the molar concentration of multi-valent anions in the adjusted feed is less than 75% of the molar concentration of multi-valent anions in initial feed. This can, for instance, have advantage when the osmotic pressure of the membrane reject stream is otherwise above or close to the available pump or spiral-wound module maximum pressure limit. In some embodiments, sufficient water is added during the process of adding one or more salts to the initial feed, such that the molar concentration (mol/L) of multi-valent anions in the adjusted feed is less than 90%, more preferably less than 75%, of the molar concentration (mol/L) of multi-valent anions in the initial feed. The additional water may be derived from a portion of solution that permeated the membrane. In some cases, the adjusted feed comprises the initial feed, added salts, and at least a part of liquid that had permeated through the membrane. Most preferably, the additional water is derived by separating the first outlet stream into a dilute and concentrated portion, such as through reverse osmosis, and at least a part of the dilute portion is recycled. At the same time that the concentration of multi-valent anions is reduced in the adjusted feed compared to in the initial feed, it is preferred that the flow of the membrane permeate stream exceeds the flow of the initial feed flow.

Different hyperfiltration membranes may be used to treat the adjusted feed. The membrane preferably comprises a polymer layer selected from the group consisting of a fully aromatic polyamide, a semi-aromatic polyamide, a sulfonated polysulfone, a sulfonated polyethersulfone, and a polysulfonamide. Hyperfiltration membranes used in this invention are most preferably those made by interfacial polymerization. Although there are variations, a common approach involves forming a thin-film interfacially polymerized layer upon a porous support, typically a polysulfone or polyether sulfone with pore sizes between 0.001 and 0.5 μm. An aqueous polyfunctional amine is applied on the support surface and a non-polar solution (e.g. hexane, Isopar™, Freon™) containing polyfunctional amine-reactive monomers is applied thereon. Once brought into contact with one another, the polyfunctional amine-reactive monomers and polyfunctional amine monomers react at the interface to form a polyamide layer or film. This layer, often referred to as a polyamide “discriminating layer” or “thin film layer,” provides the composite membrane with its principal means for separating solute (e.g. salts) from solvent (e.g. aqueous feed). It has been found that polyamide membranes made by this approach exhibit a pH dependence and mixed ion rejection that favors improved lithium recovery at the specified conditions.

A wide variety of monomers may be used at different concentrations and polymerization conditions. Polyfunctional amine monomers have at least two primary or secondary amino groups and may be aromatic (e.g., m-phenylenediamine, p-phenylene-diamine, 1,3,5-triaminobenzene, 1,3,4-triaminobenzene, 3,5-diaminobenzoic acid, 2,4-diaminotoluene, and 2,4-diaminoanisole) or aliphatic (e.g., piperazine, ethylene-diamine, propylenediamine, and tris (2-diaminoethyl) amine). Polyfunctional amine-reactive monomers include at least two and preferably two to four amine-reactive moieties selected from acyl halide, sulfonyl halide and anhydride. These monomers may be aromatic or aliphatic (straight chain or cyclic). Individual species may be used alone or in combination. Non-limiting examples of aromatic polyfunctional acyl halides include: trimesic acid chloride, terephthalic acid chloride, isophthalic acid chloride, biphenyl dicarboxylic acid chloride, napthalenetrisulfonyl chloride, and naphthalene dicarboxylic acid dichloride. Non-limiting examples of alicyclic polyfunctional acyl halides include: cyclopropane tri carboxylic acid chloride, cyclopentane tri carboxylic acid chloride, cyclohexane tri carboxylic acid chloride, cyclopentane dicarboxylic acid chloride, cyclobutane dicarboxylic acid chloride, cyclohexane dicarboxylic acid chloride, and tetrahydrofuran dicarboxylic acid chloride. Non-limiting examples of aliphatic halides include adipoyl chloride, malonyl chloride, glutaryl chloride, and sebacoyl chloride. A fully aromatic polyamide may be created by reacting an aromatic polyfunctional amine (e.g., m-phenylenediamine, p-phenylenediamine) and an aromatic polyfunctional amine-reacting monomer (e.g., trimesic acid chloride, terephthalic acid chloride). A semi aromatic polyamide may be created by picking an aliphatic polyfunctional amine (e.g., piperazine, ethylenediamine) or an aliphatic polyfunctional amine-reacting monomer (e.g., cyclopropane tri carboxylic acid chloride, cyclopentane tri carboxylic acid chloride) to form the membrane (while the other monomer contains an aromatic ring). A polysulfonamide membrane may be created by using an aromatic or aliphatic polyfunctional amine monomer and a polyfunctional sulfonyl halide—containing monomer (non-limiting examples are 1,3,5-benzenetrisulfonyl trichloride, 1,3,5-naphthalenetris(sulfonyl chloride)) to form the membrane.

Various reactive and non-reactive additives may be present during the reaction that can influence the membrane's performance properties: surfactants and phase transfer catalysts, co-solvents/solvents, organic molecules, inorganic salts, and nanoparticles. Similarly, the membrane may also be modified by different post-treatments after the reaction, including reactive and non-reactive polymer coatings, reaction to modify end-groups, plasma treatment, swelling agents, surfactants, and exposure to chlorine or mineral acids (e.g. hot phosphoric acid).

The second outlet stream, that is, the reject stream from the membrane unit is typically rich in multi-valent ions (both cations and anions) compared to the first outlet stream, that is, the permeate stream. In some embodiments, specific ions within the second outlet stream may be further isolated from others in that same stream. Preferably, the second outlet stream is further fractionated to form a part that is enriched in ions selected from monovalent anions and multi-valent cations. Preferably, the enrichment may be accomplished by passing at least a portion of the second outlet stream through a distillation column, through an ion-exchange resin column, or through a membrane system. In more preferred methods, the process of fractionating the second outlet stream uses a component selected from a membrane and an ion-exchange column. For example, a nanofiltration membrane may be employed to separate monovalent anions from multivalent anions, forming a permeated portion enriched in monovalent anions. In another example, this second outlet stream, which is rich in multivalent anions, may be fractionated by passing it through a cation-exchange resin column and then regenerating the column to create a regenerate portion richer in divalent cations. In some methods it is advantageous to use HCl or HNO₃ to regenerate the cation-exchange resin as the ion-exchange process will produce a stream enriched in ions selected from monovalent anions (Cl⁻ or NO₃⁻) and multi-valent cations. In some methods, the enriched part can be diluted with water or any aqueous solution before, during, or after the fractionation.

In addition, a part of the second outlet stream, which is enriched in ions selected from monovalent anions and multi-valent cations, can be recycled to combine with the initial feed upstream of the membrane. In creating the adjusted feed, this enriched portion can contribute to the salts added to the initial feed for purpose of adjusting its composition. Recycling this portion of the second outlet stream reduces the amount of new salts which need to be brought on site for the recovery of lithium.

In some preferred methods, the lithium dissolved in the first outlet stream may be concentrated by de-watering. For the purposes of this invention, “de-watering” means reducing the volume of water per unit mass of dissolved lithium to cause an increase in the concentration of dissolved lithium ions. For example, thermal evaporation of water from the first outlet stream may be performed using an evaporator or a distillation column. More preferably, the first outlet stream may be passed through a second membrane system (e.g. reverse osmosis) to selectively pass water in preference to ions, complementarily creating a stream that is more concentrated in lithium ions. In a less-direct process, the first outlet stream may be passed through a cation-exchange media, where cations are preferentially adsorbed. Then, the cation-exchange media is regenerated, i.e., the cations are unloaded or desorbed, for example by treatment with an acid solution, to produce an ‘eluted’ stream that is more concentrated (de-watered). In some methods, concentrating lithium by de-watering the first outlet stream is particularly useful in energy and waste management aspects.

The first outlet or permeate stream may comprise monovalent cations other than lithium. Non-limiting examples of other monovalent cations are the cations of Na, K, Cs, and Rb. The removal of the other monovalent cations (along with multi-valent cations) from the first outlet stream is desirable due to the high purity requirements of battery grade lithium (99.5% purity). The purity of battery grade lithium is defined as the lithium salt (generally carbonate salt of lithium) content, by wt. %, in the final solid product. In the present invention, a preferred method further comprises a process of fractionating the first outlet stream into two solutions, wherein one of the two solutions comprises an increased molar concentration of lithium ions compared to the molar concentration of lithium ions in the first outlet stream and a decreased molar concentration of the other (non-lithium) monovalent cations compared to the molar concentration of the other (non-lithium) monovalent cations in the first outlet stream. Fractionation of the first outlet stream may be done before, during, or after any step for concentrating (by dewatering) the dissolved lithium ions that was partitioned into the first outlet stream.

Fractionation of the first outlet stream may be accomplished by various processes. In some preferred embodiments, the first outlet stream may be passed through a media which is selective for lithium. Non-limiting examples of common lithium-selective media are inorganic lithium intercalates, examples of which (inorganic lithium intercalates) include, but are not limited to, iron phosphate, lithium aluminum hydroxide chloride, lithium manganese oxide, and lithium titanium oxide. The lithium ions can be adsorbed into these media and then desorbed with a suitable eluent such as water. The lithium ions in these materials may also be extracted by ion exchange methods in which an additive is used to displace the lithium. Common additives in this embodiment are acids such as sulfuric acid or hydrochloric acid. The eluent solution may comprise an increased molar concentration of lithium ions compared to molar concentration of lithium ions in the first outlet stream and a decreased molar concentration of the non-lithium monovalent cations compared to the molar concentration of the non-lithium monovalent cations in the first outlet stream.

In some methods, the first outlet stream can be fractionated by passing through an ion exchange media. Suitable common media include, but are not limited to, poly(co-styrene-divinylbenzene), poly(co-methylmethacrylic acid-divinyl benzene), media that may be further functionalized to contain cation binding groups such as sulfonic acid, carboxylic acid, weak bases, and combinations of two or more of these media. The ion-exchange media is preferably be suitable for cation exchange, so that the fractionation of monovalent cations may be achieved chromatographically, that is, the lithium and other monovalent cations flow through the media at different rates and have differing retention times. This process may be aided by the use of additional eluent solution which aids in the separation of lithium ions from other monovalent cations. Suitable eluent solutions include but are not limited to solutions of acids such as sulfuric acid or hydrochloric acid.

In some other methods, the first outlet stream is fractionated by selective precipitation of one or more monovalent cations, followed by filtration or decanting. In this method, an anion is selected such that the resulting lithium-anion salt has lower solubility than the other monovalent cation-anion salts that are present in the first outlet stream. Suitable anions include, but are not limited to, carbonate and oxalate. Alternatively, this method may involve the selective precipitation of the salts of non-lithium monovalent cations. In this method, fractionation may be achieved in which the solubility of lithium-anion salt is higher than the other monovalent cation-anion salts resulting in their precipitation. Suitable lower-solubility salts include, but are not limited to, sodium chloride and sodium bromide.

The following examples are provided to describe the invention in further detail. These examples, which set forth specific embodiments and a preferred mode presently contemplated for carrying out the invention, are intended to illustrate and not to limit the invention.

### EXAMPLES

### Description of Making of an Initial Feed Water

An initial feed was prepared by dissolving SO₄²⁻ salts of Li⁺, Na⁺, K⁺, Ca²⁺, Mg²⁺, Fe²⁺, Mn²⁺, Sr²⁺, Zn²⁺, and Al³⁺ in de-ionized water (DIW). The initial feed pH was adjusted to a value of 1.4-1.5 by adding an appropriate amount of 98% sulfuric acid solution. The dissolved mass of Lithium was 0.33 g/L. The initial feed cation concentrations (mol/L) were measured as Li⁺=0.05, Na⁺=0.08, K⁺=0.004, Ca²⁺=0.01, Mg²⁺=0.21, Fe²⁺=0.014, Mn²⁺=0.001, Sr²⁺=0.002, Zn²⁺=0.0007, and Al³⁺=0.02. The major anion in the initial feed was SO₄²⁻ with an ionic concertation of 0.378 mol/L.

The initial feed did not contain any monovalent anion other than small amounts of hydroxide from water dissociation. Therefore, the initial ratio of monovalent anions to lithium ions was zero. Similarly, the initial ratio of monovalent anions to multi-valent anions was zero. The initial ratio of multi-valent cations to lithium ions was 5.4. In Examples 1 and 2, the initial feed was used as the feed stream for the filtration tests, that is, there was no separate adjusted feed.

### Description of Making of an Adjusted Feed Water

In Examples 3 through 14, an adjusted feed was prepared by adding one or more salt solutions to the initial feed solution. Details of the adjusted feed preparations are provided in specific examples. Ion concentrations (mol/L) were used to calculate adjusted ratios of monovalent anions to lithium ions.

### Description of Filtration Test Protocols and Analytical Measurements

Filtration tests in Examples 1-14 were performed to measure and compare lithium passage, mass recovery, and the ratio of multi-valent cations to lithium ions in the membrane permeate stream of specific membranes operated with different feeds and operating conditions.

Tests were performed under a crossflow configuration by pressurizing the feed using a pump and passing the feed across membrane coupons housed in standard-membrane filtration cells. Each cell housed a rectangular membrane coupon with an active area of 42 cm² cut from flat membrane sheets. The membrane unit contained six membrane filtration cells, and therefore, the total active area that came in contact to the feed was 252 cm² (0.27 ft²). In these examples, each membrane filtration cell with a membrane is considered as the membrane module and all six cells/modules combined is considered as the membrane unit. These six membrane filtration cells were positioned in two parallel banks of three cells each connected in series. The membrane active side was exposed to the feed solution. A feed volumetric flow rate of 2 L/minute per bank was maintained during the entire test. The portion of the feed that passed through the membrane, the membrane permeate stream, was collected from the individual membrane filtration cell permeate line. The portion of the feed that did not pass through the membrane, the membrane reject stream, was recycled back to the feed tank upstream of the pump for the entire test period. Unless otherwise mentioned in any specific example, the membrane permeate streams were also recycled back to the feed tank upstream of the pump except during the permeate stream collection period. All filtration tests were conducted at a feed temperature range of 23-27 °C.

Permeates streams collected from the individual membrane filtration cells were weighed using an analytical balance and the membrane flux (volume per unit area per unit time) was calculated by correcting the measured permeate weight for the permeate collection time and the membrane active area. Flux values were averaged over six permeates collected (one from each membrane filtration cell) and are reported in units of liter/m²/h (LMH). A permeate stream density of 1 g/ml was used for flux calculations.

Ion concentrations (mol/L) were analyzed for both the permeate stream and the feed stream. The feed stream was collected from the feed tank at the same time the permeate streams were collected. The feed stream ion concentrations did not change significantly during the time of experiment when both the reject and the permeate streams were recycled back to the feed tank. In some cases (e.g. Example 14) the feed stream ions concentrations changed with time due to continuous collection of the permeate stream or due to occasional addition of water to the feed tank to reduce osmotic pressure.

To measure the ion concentration in the permeate stream, all six membrane permeate streams were mixed to prepare a ‘mixed permeate’ stream. The cation mass concentrations were analyzed by an inductively coupled plasma—optical emission spectroscopy (ICP-OES) method using an iCap 7600 ICP-OES analyzer available from Thermo Scientific of Waltham, MA. The cation concentrations were calculated by dividing the ICP-OES mass concertation by the corresponding ion molar mass. These ion concentrations were used to calculate the ion ratio of multi-valent cations to lithium in the (mixed) permeate stream. The ion passages (fraction, abbreviated as “fr.”) were calculated as a ratio of an ion molar concentration in the (mixed) permeate stream to the corresponding feed stream, both measured using the ICP-OES.

The membrane unit volumetric recovery was calculated as the volume of permeate liquid produced by the membrane unit divided by the volume of liquid provided to the membrane unit over the same time period and reported in %. In most cases illustrated here, the membrane unit recovery was less than 2% and these tests were specifically for the purpose of demonstrating how the relative permeate concentrations of different ions can be modified by changing the adjusted feed. One can recognize that the both the volumetric recovery and the fraction of lithium ions recovered (into the permeate stream) can be increased through use of more membrane area in series, by passing less feed solution through the membrane unit at the same average flux, or by recycling the membrane reject stream while continuing to withdraw permeate.

In one specific example (Example 14), the membrane reject stream of the membrane unit was recycled and recovery of the system was measured and reported. For this example, the lithium ion mass recovery was also calculated by dividing the lithium ions mass dissolved in the permeate stream (the first outlet stream) by the lithium ions mass dissolved in the initial feed and expressed as a fraction. The lithium ions mass dissolved in the permeate stream was calculated by multiplying the permeate volume (collected volume of the first outlet stream) by the mass concentration of dissolved lithium ions measured by the ICP-OES. The lithium ions mass dissolved in the initial feed was calculated by using the mass of the Li-containing reagent used to prepare the initial feed multiplied by the weight fraction of the Li ion in the reagent.

Examples (1 and 2) illustrate the control cases where the initial feed was directly fed to the membranes without any salt addition (i.e. without any pH and/or ion ratio adjustment).

EXAMPLE 1: The membrane used in this example is a composite membrane with a piperazine-based polyamide barrier layer that is used in FilmTec's commercial SR90 elements. The previously described initial feed was supplied to the membrane unit.
EXAMPLE 2: In Example 2, membranes coupons were cut from a sheet of Duracid polysulfonamide membrane commercially available from Suez. The initial feed was used as the feed to the membrane unit.

Examples 3 to 6 illustrate the impact of salt addition to the initial feed to provide the specified adjusted feed pH and/or ion ratio before membrane unit.

EXAMPLE 3: In Example 3 an initial feed was prepared as described above except without adding any Fe²⁺, Zn²⁺, or Sr²⁺ ions. Therefore, in this example, the initial feed cation concentrations in mol/L unit were Li⁺=0.05, Na⁺=0.08, K⁺=0.004, Ca²⁺=0.01, Mg²⁺=0.21, Mn²+=0.001, and Al³⁺=0.02. The pH of the initial feed was adjusted to 1.4 to 1.5 by adding an appropriate amount of 98% sulfuric acid solution to the salt solution. The major anion in the initial feed was SO₄²⁻ with an ionic concentration of 0.368 mol/L. The initial feed did not contain any monovalent anion other than small amounts of hydroxide from water dissociation. Therefore, the initial ratio of monovalent anions to lithium ions was zero. Similarly, the initial ratio of monovalent anions to multi-valent anions was zero. The initial ratio of multi-valent cations to lithium ions was 5.1.

Lithium hydroxide powder (Li(OH)·H₂O, 41.95 g) was dissolved in de-ionized water to produce a solution of Li(OH) (1 liter, 1 mole/liter). An appropriate amount of this salt solution was added to the initial feed, as described above, to raise the pH. Any precipitate generated during the pH adjustment was removed using a Fisherbrand 0.2μ aPES membrane filter and the filtrate pH was measured to be 4.2. The filtrate collected after removal of precipitated solids is the adjusted feed, and this was passed across the membrane.

This adjusted feed was tested using a similar membrane and testing procedure as described in Example 1. The adjusted ratio of monovalent anions to lithium ions was zero as no other monovalent anions were present other than small amounts of hydroxide from water dissociation. The lithium ion concentration in the adjusted feed was 0.15 mol/L.

EXAMPLE 4: This is similar to Example 3. However, after removal of precipitated solids, an adjusted feed was formed by adding 0.03 mol/L MgCl₂·6H₂O salt in solid form to the of filtrate. This filtrate with the Cl⁻ ions (solution pH 4.4) was sent to the membrane unit. The Cl⁻ ion concentration in the adjusted feed was 0.06 mol/L. The adjusted ratio of monovalent anions to lithium ions was 0.4. The adjusted feed lithium concentration was 0.14 mol/L.
EXAMPLE 5: This is similar to Example 4 except the Cl⁻ ion concentration in the adjusted feed (solution pH 4.2) was 0.3 mol/L. The adjusted ratio of monovalent anions to lithium ions was 2.1. The adjusted feed lithium concentration was 0.14 mol/L.
EXAMPLE 6: This is similar to Example 4 except the Cl⁻ ion concentration in the adjusted feed (solution pH 4.2) was 0.6 mol/L. The adjusted ratio of monovalent anions to lithium ions was 4.3. The adjusted feed lithium concentration was 0.14 mol/L.

The feed compositions and filtration test performances for Example 1-6 are reported in Table 1. As is apparent from data of the Table 1, both Li⁺ passage to the permeate stream increased and the multivalent cations to lithium ions ratio in permeate decreased when both the pH and monovalent anions to lithium ions ratio were adjusted by adding specific salts.

TABLE 1

| | | | | Monovalent | | |
|---|---|---|---|---|---|---|
| | | | | anions to lithium | | Multi-valent |
| | | Applied | Permeate | ions ratio in the | | cations to lithium |
| | Feed | pressure | flux | feed sent to the | Li⁺ passage in | ions ratio in |
| Example | pH | (bar) | (LMH) | membrane | permeate (fr.) | permeate |
| 1 | 1.4 | 15.5 | 17.9 ± 0.3 | 0 | 0.45 | 0.07 |
| 2 | 1.4 | 32.8 | 18.7 ± 0.9 | 0 | 0.25 | 2.12 |
| 3 | 4.3 | 17.2 | 19.4 ± 0.3 | 0 | 0.06 | 0.160 |
| 4 | 4.4 | 16.4 | 18.2 ± 0.3 | 0.4 | 0.31 | 0.013 |
| 5 | 4.2 | 20.3 | 18.7 ± 0.5 | 2.1 | 0.87 | 0.013 |
| 6 | 4.2 | 29.0 | 17.5 ± 0.3 | 4.3 | 1.16 | 0.025 |

Examples (7-8) illustrate applicability of the invention at different feed pH values.

EXAMPLE 7: Example 7 uses the same conditions (membrane, initial feed preparation, adjusted feed preparation, and testing) as Example 5, except that the adjusted feed pH was pH 6.6, the Cl⁻ ion concentration in the adjusted feed was 0.3 mol/L, the adjusted ratio of monovalent anions to lithium ions was 2.0, and the lithium concentration in the adjusted feed was 0.15 mol/L.
EXAMPLE 8: Example 8 uses the same conditions (membrane, initial feed preparation, adjusted feed preparation, and testing) as Example 5, except that the adjusted feed pH was pH 3.5, the Cl⁻ ion concentration in the adjusted feed was 0.3 mol/L, the adjusted ratio of monovalent anions to lithium ions was 3.0, and the lithium concentration in the adjusted feed was 0.10 mol/L.

The feed composition and filtration test performances for Example 7-8 are reported in Table 2.

TABLE 2

| | | | | Monovalent | | |
|---|---|---|---|---|---|---|
| | | | | anions to lithium | | Multi-valent |
| | | Applied | Permeate | ions ratio in the | | cations to lithium |
| | Feed | pressure | flux | feed sent to the | Li⁺ passage in | ions ratio in |
| Example | pH | (bar) | (LMH) | membrane | permeate (fr.) | permeate |
| 7 | 6.6 | 19.0 | 18.2 ± 0.2 | 2.0 | 0.84 | 0.028 |
| 8 | 3.5 | 22.0 | 18.7 ± 0.5 | 3.0 | 0.85 | 0.014 |

Examples (9-13) illustrate the use of different types and amounts of salts to form an adjusted feed with different pH and/or ion ratio.

EXAMPLE 9: Example 9 uses the same conditions (membrane, initial feed preparation, adjusted feed preparation, and testing procedure) as Example 3, except that Mg(OH)₂ salt in solid form was added to the initial feed for pH adjustment. After the removal of precipitates generated during the pH adjustment, the adjusted feed solution pH was measured to be 4.2. The adjusted ratio of monovalent anions to lithium ions was zero as no other monovalent anions were present other than small amounts of hydroxide from water dissociation. The adjusted feed lithium concentration was 0.044 mol/L.
EXAMPLE 10: Example 10 is similar to Example 9, except that after removal of precipitated solids, 0.015 mol MgCl₂·6H₂O salt was added to per L of filtrate. The filtrate with the Cl⁻ ions formed the adjusted feed (solution pH 4.3) which was passed across the membrane surface. The Cl⁻ ion concentration in the adjusted feed was 0.03 mol/L. The adjusted ratio of monovalent anions to lithium ions was 0.7. The adjusted feed lithium concentration was 0.044 mol/L.
EXAMPLE 11: In this example, conditions were similar to Example 10 except the Cl⁻ ion concentration in the adjusted feed (solution pH 4.2) was 0.16 mol/L and the adjusted ratio of monovalent anions to lithium ions was 3.6. The adjusted feed lithium concentration was 0.044 mol/L.
EXAMPLE 12: In this example, conditions were similar to Example 10 except that the Cl⁻ ion concentration in the adjusted feed (solution pH 4.2) was 0.32 mol/L, the adjusted ratio of monovalent anions to lithium ions was 7.0, and the adjusted feed lithium concentration was 0.043 mol/L.
EXAMPLE 13: In this example, conditions were similar to Example 9 except that, after removal of precipitated solids, 0.30 mol/L NO₃⁻ in the form of Mg(NO₃)₂·6H₂O salt was added to the filtrate. The filtrate with the NO₃⁻ ions is the adjusted feed (solution pH 4.2) which was passed across the membrane surface. The adjusted ratio of monovalent anions to lithium ions was 6.8. The adjusted feed lithium concentration was 0.044 mol/L.

The feed composition and filtration test performances for Examples 9-13 are reported in Table 3.

TABLE 3

| | | | | Monovalent | | |
|---|---|---|---|---|---|---|
| | | | | anions to lithium | | Multi-valent |
| | | Applied | Permeate | ions ratio in the | | cations to lithium |
| | Feed | pressure | flux | feed sent to the | Li⁺ passage in | ions ratio in |
| Example | pH | (bar) | (LMH) | membrane | permeate (fr.) | permeate |
| 9 | 4.2 | 16.9 | 18.2 ± 0.2 | 0 | 0.12 | 0.390 |
| 10 | 4.3 | 16.5 | 20.2 ± 0.2 | 0.7 | 0.30 | 0.047 |
| 11 | 4.2 | 17.9 | 15.5 ± 0.2 | 3.6 | 0.70 | 0.040 |
| 12 | 4.2 | 22.9 | 16.8 ± 0.2 | 7.0 | 0.96 | 0.046 |
| 13 | 4.2 | 21.4 | 17.0 ± 0.2 | 6.8 | 1.05 | 0.063 |

Example 14 illustrates Li mass recovery in a system of greater volumetric recovery.

EXAMPLE 14: A sulfate-based initial feed was prepared having cation concentrations (mol/L) for Li⁺=0.043 and Mg²⁺=0.173. The initial feed also contained sulfuric acid and the initial feed pH was 1.55. The initial feed did not contain any monovalent anion other than small amounts of hydroxide from water dissociation. Therefore, the initial ratio of monovalent anions to lithium ions was zero. Similarly, the initial ratio of monovalent anions to multi-valent anions was zero. The initial ratio of multi-valent cations to lithium ions was 4.0.

Here, a recirculating system was configured to reasonably simulate the performance of a continuous filtration system having more membrane area. In this example, an ion ratio adjustment was performed by adding MgCl₂·6H₂O salt in powder form to the initial feed. The concentration of Cl⁻ ions in the adjusted feed was 0.4 mol/L. An appropriate amount of Mg(OH)₂ powder was added subsequently to raise the solution pH. Precipitated solids generated during pH adjustment were removed using a Fisherbrand 0.2 aPES membrane filter and the filtrate pH was measured to be 4.3. This filtrate was the ‘adjusted feed’ that was fed to the membrane unit. The adjusted ratio of monovalent anions (Cl⁻) to lithium ions was 9.3. The adjusted feed lithium concentration was 0.043 mol/L. This adjusted feed was tested using a similar membrane as described in Example 1.

Adjusted feed (10.1 L, weight 10378 g) was pumped through a membrane unit containing six flat-sheet coupons with a combined active area of 252 cm². During the entire test, the first outlet stream, that is, the permeate streams leaving the membrane unit, were collected in a bucket while the membrane reject stream was recycled to the feed tank (upstream of the feed pump, as shown in FIG. 3). As the feed tank osmotic pressure increased, the feed side pressure was adjusted to increase the permeate flow. After 9 hours of operation, 5.45 L of permeate (weight 5401 g) was collected. This collected solution is called permeate A.

After permeate A collection, 0.5 L of de-ionized water (DIW) was added to the feed tank and permeate streams were collected for another 1.5 hours. This collected solution volume was 0.71 L (weight 705.4 g) and is called permeate B. Further, another 0.5 L of DIW was added to the feed tank and permeate streams were collected for another 3 hrs. This collected solution volume was 1.0 L (weight 1003.7 g) and is called permeate C.

The membrane unit volume recovery and Li mass recovery data are presented in Table 4.

TABLE 4

| | Permeate | Average Permeate | Permeate | Volume recovery (%) | Li mass |
|---|---|---|---|---|---|
| Example | stream | flux (LMH) | volume (L) | of membrane unit | recovery, fr. |
| 14 | A | 27.3 | 5.45 | 54.0 | 0.64 |
| 14 | B | 19.0 | 0.71 | 7.0 | 0.08 |
| 14 | C | 13.4 | 1.0 | 9.9 | 0.10 |

When Permeate A, B, and C were combined, the membrane unit volume recovery was 70.9% of the adjusted feed volume or 64.5% of the adjusted feed and added DIW volume combined. The Li mass recovery was 0.82 and the ratio of multi-valent cations (Mg²⁺) to lithium ions was 0.2 (i.e. 0.05 times of the same ratio in the initial feed, 4.0).

The methods described herein find particular utility in selective recovery of lithium from a brine feed with a high mass recovery and purity. Another advantage of the present methods is that multi-valent anions (e.g. SO₄²⁻, CO₃²⁻) in an initial feed containing lithium ions may be exchanged by monovalent anions (e.g. Cl⁻, NO₃⁻) in the permeate of a membrane system, forming a composition which may be more beneficial for downstream lithium recovery operations.

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of recovering lithium comprising the steps of:
providing an initial feed with a dissolved mass of lithium and
a) an initial ratio of monovalent anions to lithium ions,
b) an initial ratio of multi-valent cations to lithium ions, and
c) an initial ratio of monovalent anions to multi-valent anions that is less than one;
adding one or more salts to the initial feed to create an adjusted feed with pH between 1 and 7 and
d) an adjusted ratio of monovalent anions to lithium ions that is more than the initial ratio of monovalent anions to lithium ions; and
passing a portion of the adjusted feed through a membrane unit to produce a first outlet stream and a second outlet stream, wherein at least half of the mass of lithium present in the initial feed is partitioned into the first outlet stream and the first outlet stream has a ratio of multi-valent cations to lithium ions that is less than half of the initial ratio of multi-valent cations to lithium ions.

2. The method of claim 1 wherein the adding of one or more salts to the initial feed creates an adjusted ratio of multi-valent cations to lithium ions that is greater than the initial ratio of multi-valent cations to lithium ions.

3. The method of claim 1, wherein the majority of multi-valent anions in the initial feed are sulfate ions, and the ratio of monovalent anions to multi-valent anions in the initial feed is less than 0.5.

4. The method of claim 1, further comprising combining the initial feed with additional water, such that the molar concentration of multi-valent anions in the adjusted feed is less than 90% of the molar concentration of multi-valent anions in the initial feed.

5. The method of claim 1, wherein the adjusted feed comprises the initial feed, added salts, and at least a part of a liquid that had permeated through a membrane of the membrane unit.

6. The method of claim 1, wherein the membrane comprises a polymer layer selected from the group consisting of a fully aromatic polyamide, a semi-aromatic polyamide, a sulfonated polysulfone, a sulfonated polyethersulfone, and a polysulfonamide.

7. The method of claim 1, further comprising a step of fractionating the second outlet stream to form a part that is enriched in ions selected from monovalent anions and multi-valent cations, and wherein the step of fractionating uses a component selected from a hyperfiltration membrane and an ion-exchange resin.

8. The method of claim 7, wherein at least a portion of the enriched part is recycled, and the adjusted feed comprises the initial feed and at least a portion of the enriched part.

9. The method of claim 1, further comprising concentrating the first outlet stream by de-watering to result in an increased concentration of dissolved lithium.

10. The method of claim 1, wherein the first outlet stream comprises at least one monovalent cation other than lithium, and further comprising the step of fractionating the first outlet stream into two solutions, wherein one of the two solutions comprises an increased molar concentration of lithium ions compared to the molar concentration of lithium ions in the first outlet stream and a decreased molar concentration of the monovalent cation compared to the molar concentration of the monovalent cation in the first outlet stream.

11. The method of claim 1, further comprising the step of extracting lithium from the first outlet stream.

12-15. (canceled)
